(19) United States
(12) Patent Application Publication
(10) Pub. No.: US 2021/0252535 A1
(43) Pub. Date: Aug. 19, 2021

(54) HIGH-PRESSURE CLEANING DEVICE, CLEANING DISPERSION AND ARRANGEMENT OF HIGH-PRESSURE CLEANING DEVICE IN RELATION TO A SURFACE

(71) Applicant: WashTec Holding GmbH, Augsburg (DE)

(72) Inventors: Andreas SATTLER, München (DE); Stefan MAYER, Neusäss (DE)

(21) Appl. No.: 17/251,095

(22) PCT Filed: Jun. 13, 2019
(86) PCT No.: PCT/EP2019/065601

§ 371 Date: Dec. 10, 2020

(30) Foreign Application Priority Data
Jun. 27, 2018 (DE) 10 2018 115 510.7

(51) Int. Cl. B05B 7/14; B08B 3/02; B08B 3/08; B60S 3/04; B24C 11/00

(52) U.S. Cl. CPC B05B 7/1431; B08B 3/022; B08B 3/08; B60S 3/04; B05B 15/25; B24C 11/00; B08B 2203/0258; B08B 2203/0223; B08B 2203/0217; B05B 7/1481

(57) ABSTRACT

A high-pressure cleaning device, a cleaning dispersion, and a combination of a high-pressure cleaning device with a surface to be cleaned. The cleaning device cleans surfaces soiled by fine particles, particularly motor vehicle surfaces, and includes a high-pressure pump for delivering a cleaning product to a high-pressure jet nozzle. The cleaning product emerges in a high-pressure jet. The cleaning product includes a cleaning dispersion with a carrier fluid and solid cleaning particles having a density of between 0.8 g/cm³ and 3.5 g/cm³. Cleaning particles emerge from the high-pressure jet nozzle having a minimum kinetic energy of 1·10⁻¹⁰ J and a maximum kinetic energy of 2·10⁻⁴ J.

### CROSS-REFERENCE TO RELATED APPLICATIONS

This application is the United States national phase entry of International Application No. PCT/EP2019/065601, filed Jun. 13, 2019, which claims the benefit of priority of German Application No. 10 2018 115 510.7, filed Jun. 27, 2018. The contents of International Application No. PCT/EP2019/065601 and German Application No. 10 2018 115 510.7 are incorporated by reference herein in their entireties.

### FIELD

The invention relates to a (brushless) high-pressure cleaning device for material-friendly cleaning, in particular fine cleaning, of surfaces contaminated with fine particles, in particular motor-vehicle surfaces, comprising a high-pressure pump for conveying a cleaning product or a cleaning agent to a high-pressure jet nozzle at which the cleaning product is discharged in a high-pressure jet. In addition, the present invention relates to a cleaning dispersion for a high-pressure cleaning device and an arrangement of a high-pressure cleaning device and a surface to be cleaned.

### BACKGROUND

The prior art shows high-pressure cleaning devices which spray a cleaning product with high pressure onto an object, such as a vehicle, in order to remove dirt particles and unwanted substances via the effect of the high-pressure jet and to achieve cleaning of the surface of the object. However, these conventional high-pressure cleaning devices have the disadvantage that even after cleaning with the high-pressure jet, fine particles remain on the surface to be cleaned, which can only be removed (for the most part) by further post-treatment, such as brush washing or manual polishing with wipes. In the field of vehicle washing, these remaining fine particles, which are deposited, for example, during normal vehicle driving, are known as so-called undesired ‘gray haze’, which is particularly striking on light, in particular white, varnished surfaces and which currently has to be removed in a costly and time-consuming post-treatment.

### SUMMARY

It is therefore the object of the present invention to prevent or at least reduce the disadvantages of the prior art and in particular to provide a high-pressure cleaning device, a cleaning product as well as an arrangement of a high-pressure cleaning device and a surface to be cleaned, with which contaminated surfaces, in particular vehicle surfaces, can be cleaned efficiently and economically as well as in a material-friendly manner, without using brushes, while reducing the cleaning time and with high cleaning success. In particular, fine particles adhering to the surface are to be reliably removed.

The object is solved in a generic (vehicle) high-pressure cleaning device according to the invention in that the cleaning product is a cleaning dispersion with a carrier fluid, in particular water, and with solid cleaning particles with a density between 0.8 g/cm³ and 3.5 g/cm³, in particular between 0.9 g/cm³ and 2.2 g/cm³, and the high-pressure cleaning device is configured in such a way that a cleaning particle, on leaving the high-pressure jet nozzle, has a kinetic energy of at least 1·10⁻¹⁰ J and at most 2·10⁻⁴ J, preferably of at least 2·10⁻⁹ J and at most 7·10⁻⁵ J, and particularly preferably between at least 4·10⁻⁷ J and at most 9·10⁻⁶ J. The high-pressure jet of the high-pressure cleaning device exiting from the high-pressure jet nozzle is formed by a cleaning dispersion with solid cleaning particles, which have to meet a special range of density for an optimal (cleaning) effect and also have to exit the high-pressure jet nozzle of the high-pressure cleaning device with a predetermined kinetic energy. It has been proven in elaborate series of experiments and analyses that exactly these two parameters, i.e. the density of the cleaning particles and the kinetic energy of a single cleaning particle when exiting the high-pressure jet nozzle, are the decisive parameters for an optimal cleaning effect in terms of removing fine particles from surfaces. If one of the two parameters of the cleaning particle is outside the specified range in a high-pressure cleaning device, then either no cleaning effect is achieved if the value falls below the specified range or the surface to be cleaned is damaged if the value is exceeded. Within a two-dimensional characteristic diagram, the parameters density and kinetic energy limit the (effective) range to be achieved.

The advantage of the high-pressure cleaning device with the cleaning dispersion according to the invention is in particular also to be seen in the fact that even surfaces can be cleaned very well with it which are in gaps or undercuts, for example at a B-pillar of the vehicle, at a mirror or at a rear spoiler, since the cleaning particles can penetrate into areas, which brushes usually do not reach, since they only wipe over the surface and do not reach gaps or undercuts.

Advantageous embodiments are explained below.

In a preferred variation, the cleaning particles of the cleaning dispersion of the high-pressure cleaning device can have an average longitudinal extension (longest dimension) of at least 20 μm and/or at most 315 μm, in particular at least 30 μm and/or at most 200 μm. It has been shown that a further, essential parameter, which influences the cleaning result of the high-pressure cleaning device, is the dimension of the cleaning particles contained in the high-pressure jet. The lower limit of the parameter dimension of 20 μm ensures that the fine particles are removed by the impact pulse. On the other hand, up to the upper limit of the dimension, good handling and a still satisfactory cleaning effect can be guaranteed. If the cleaning particles are too large, they tend to settle in pipes and hoses and form lumps when they are whirled up, which can block mechanical components or close off nozzles.

Preferably, the speed of the high-pressure jet when exiting the high-pressure jet nozzle can be at least 20 m/s and/or at most 80 m/s, in particular at least 40 m/s and/or at most 60 m/s. The speed of the high-pressure jet when exiting the high-pressure jet nozzle corresponds to the speed of the cleaning dispersion and thus to the speed of the carrier fluid on the one hand and to the cleaning particles on the other hand. These speeds of the cleaning dispersion or the cleaning particles have proven to be particularly advantageous for cleaning.

According to a further aspect of the invention, the high-pressure cleaning device may have a receiver tank/reservoir for storing the cleaning dispersion, which comprises a circulating device for circulating the cleaning dispersion in order to keep the distribution of the cleaning particles homogeneous, wherein the circulating device is designed in particular in the form of a stirring device, a circulating pump, or an aerator which blows air into the cleaning dispersion. The circulation device ensures that the cleaning particles are not deposited on the bottom or the surface of the receiver tank, but that a homogeneous mixture of the cleaning dispersion is maintained. The cleaning dispersion also meets the necessary requirements for good storage and stirrability.

In a preferred embodiment, the high-pressure cleaning device can have a supply line upstream of the high-pressure pump, which feeds the ready-to-use cleaning dispersion with the cleaning particles and the carrier fluid, which in particular contains water as carrier fluid, in front of the high-pressure area. In this variant, the cleaning dispersion can either be sucked in before the high-pressure area via a vacuum of the high-pressure pump or the cleaning dispersion can be fed to the high-pressure pump with the help of a booster pump.

In an alternative embodiment, the high-pressure cleaning device can have two feed lines upstream of the high-pressure pump, in which a first feed line (as supply line) feeds an undiluted cleaning agent/cleaning agent concentrate with the cleaning particles, which in particular contains a washing fluid as a carrier fluid, and in which a second feed line feeds another fluid, in particular water, which together as a mixture form the ready-to-use cleaning dispersion, so that the undiluted cleaning agent and the water are mixed before the high-pressure area. In this way, the special undiluted cleaning agent can be kept compact for easy transport, storage and handling, whereas the larger part of the (ready-to-use) cleaning dispersion in terms of mass and volume, i.e. the additional fluid, in particular water, can be added to the high-pressure device on site. For example, the cleaning device can be connected directly to a local water supply, so that only the undiluted cleaning agent has to be provided by a supplier.

According to a further aspect, the high-pressure cleaning device can have a concentrate container (as receiver tank) for the storage of the undiluted cleaning agent, and the undiluted cleaning agent can be supplied via the first feed line by means of a dosing device, in particular in the form of a dosing pump. With the help of the dosing pump, an exactly defined amount of the undiluted cleaning agent can be extracted from the concentrate container and be fed to the cleaning dispersion or the high-pressure jet.

In a further, alternative embodiment, the high-pressure cleaning device may have at least one high-pressure injector before the high-pressure jet nozzle and downstream of the high-pressure pump in order to inject an undiluted cleaning agent with the cleaning particles into the high-pressure area. In this variant, the undiluted cleaning agent is added into the high-pressure area, i.e. after the high-pressure pump, in order to form the cleaning dispersion, together with a further fluid conveyed by the high-pressure pump at high pressure, before the high-pressure jet nozzle. This has the advantage that the cleaning particles are only added in an area downstream of the high-pressure pump, so that the risk of wear on the high-pressure pump is reduced. The additional fluid, in particular water, is conveyed through the high-pressure pump, takes the undiluted cleaning agent with it before the high-pressure jet nozzle, causes it to reach high pressure before it exits, and brings it to a corresponding speed with the associated kinetic energy of the cleaning particles when it exits.

In particular, the pressure generated by the high-pressure pump at the high-pressure jet nozzle can lie between 20 and 60 bar.

It is preferred that the high-pressure pump is designed as a centrifugal pump. This type of pump provides a cost-effective and compact pump for the high-pressure cleaning device, which is able to deliver a required high volume flow. Other types of high-pressure pumps are also basically conceivable.

Preferably, the at least one high-pressure jet nozzle from which the high-pressure jet exits is designed in the form of a flat fan nozzle. The flat fan nozzle and the associated large width of the high-pressure jet enable a large area to be sprayed in a defined way within a short time.

Such a high-pressure cleaning device according to the invention can in particular be designed in the form of a gantry car wash (system)/portal washer without brushes with high-pressure jet nozzles or as a car wash line with high-pressure jet nozzles. It is also possible to use the high-pressure cleaning device in a system with little or no degree of automation, e.g. in a self-service car wash, where the user can apply the cleaning dispersion manually via a high-pressure lance to the surface to be cleaned.

The object regarding a generic cleaning product for a high-pressure cleaning device, which is designed as a cleaning dispersion with a carrier fluid and solid cleaning particles dispersed or distributed in the carrier fluid, is solved according to the invention in that the cleaning particles have a density between 0.8 g/cm³ and 3.5 g/cm³. This range of the density parameter has proven to be advantageous for cleaning. Density in this context means the mass density that the base material of the cleaning particles has in solid form.

Preferably, the cleaning particles are made of a polymer. Polymers have in particular the advantage that due to their low hardness of only 1 Mohs or a SHORE D hardness of less than or equal to 95, they clean surfaces to be cleaned, in particular paint surfaces of vehicles in a material friendly way without damaging the surface. The potential for damage is thus minimized. Cleaning particles made of polymer have also proven to achieve a particularly efficient cleaning effect. A further advantage of cleaning particles made of polymers is that they strongly prevent the surface from being contaminated again by the cleaning particles themselves. A large number of technically produced polymers can be used as the polymer. The appropriate selection of the particle properties is of particular importance; the chemical nature of the polymer is of secondary importance. Polymers have the additional advantage that the cleaning particles can be easily removed after cleaning (by appropriately adjusting the size of the cleaning particles), in particular by rinsing.

Preferably, the cleaning particles contained in the cleaning dispersion have stable properties in the carrier fluid. The term ‘stable properties’ means that the properties of the cleaning particles in the cleaning dispersion do not change or do not change in a process-relevant way over time after a suitable delivery form has been prepared. In particular, no chemical or physical processes take place by which the particles change their size during storage or preparation, by which they combine to form agglomerates that are no longer soluble, or by which they dissolve completely or partially. The cleaning dispersion can be in particular stored and pumped at all times. Preferably, the requirement for the cleaning dispersion or its properties is also that it can be stirred even after a longer period of time. In particular, the cleaning particles are also temperature-stable or temperature-resistant and withstand high temperatures.

Preferably, the temperature of the cleaning dispersion is in the range of room temperature and is in particular around 20° C.

According to one aspect of the invention, the cleaning particles may contain an inorganic filler as a core, which is enclosed or encapsulated by the polymer. Such a design of the cleaning particles results in a fusion of several advantages. On the one hand, the cleaning particles are soft on the outside and their damage potential is correspondingly reduced, and on the other hand, the inorganic fillers introduced, for example spat or baryte, cause the cleaning particles to exhibit improved handling at high kinetic energy, in particular at a higher density of the filler. It should be noted that the described concept of a polymer-coated, inorganic filler of the cleaning particles is an independent invention, which may become the subject matter of a separate patent application.

Preferably, the cleaning particles of the cleaning dispersion according to the invention can have an average longitudinal extension (longest dimension) of at least 20 μm and/or at most 315 μm, in particular at least 30 μm and/or at most 200 μm.

It is preferred that the cleaning particles have a grain structure and are in particular microporous and/or have a star-shaped form. The shape of the cleaning particles also has an influence on the desired cleaning result. If the shape of the cleaning particles is not spherical, but has a grain structure, the corners and edges of a grain structure have a positive effect on the cleaning result.

In particular, the cleaning particles of the ready-to-use cleaning dispersion can have a mass percentage between 0.1% and 5%, in particular between 1% and 3%, of the cleaning dispersion. If the concentration or the mass percentage of the cleaning dispersion is too low, a necessary cleaning time will be prolonged, whereas a concentration that is too high makes the cleaning dispersion difficult to handle. A range between 0.1 and 5% weight of the cleaning particles in the cleaning dispersion therefore weighs between cleaning effect per time and handling. The concentration or the mass percentage of the cleaning particles, corresponding to a number of possible hits of the fine particles, is a decisive parameter for the cleaning success.

The object regarding a generic arrangement of a high-pressure cleaning device and a surface to be cleaned is solved according to the invention in that the cleaning product is a cleaning dispersion with a carrier fluid and with solid cleaning particles with a density between 0.8 g/cm³ and 3.5 g/cm³, in particular between 0.9 g/cm³ and 2.2 g/cm³, and the high-pressure cleaning device is configured in such a way that a cleaning particle has a kinetic energy of at least 1·10⁻¹⁰ J and at most 2·10⁻⁴ J when it hits the surface to be cleaned, preferably of at least 2·10⁻⁹ J and at most 7·10⁻⁵ J, and particularly preferably between at least 4·10⁻⁷ J and at most 9·10⁻⁶ J. In the arrangement according to the invention, both the density range of the cleaning particles and the range of the predetermined kinetic energy of the cleaning particles when they hit the surface to be cleaned are the decisive parameters for an optimal cleaning effect in order to remove fine particles from the surface. The high-pressure cleaning device can have the features of the high-pressure cleaning device according to the invention.

Preferably, in the arrangement, a distance between the high-pressure cleaning device and the surface to be cleaned, in particular between the high-pressure jet nozzle and the surface to be cleaned, can be less than 1 meter.

In an advantageous embodiment of the arrangement of the high-pressure cleaning device and the surface to be cleaned, the kinetic energy of the cleaning particles when they exit the high-pressure jet nozzle corresponds essentially to the energy when the cleaning particles hit the surface. In particular, if the cleaning dispersion contains a high percentage of a liquid carrier fluid, in particular water, the cleaning particles are transported or carried by the carrier fluid, air resistance is minimized, and the cleaning particles lose only a very small part of their kinetic energy on their way from the exit of the high-pressure jet nozzle until they hit the surface.

### BRIEF DESCRIPTION OF THE DRAWING FIGURES

The present invention is explained in more detail below on the basis of preferred embodiments with reference to the accompanying figures, of which:

FIG. 1 shows a side view of a surface according to the prior art, where fine particles remain despite an applied high-pressure jet,

FIG. 2 shows a schematic concept of a high-pressure cleaning device according to the invention of a first, preferred embodiment,

FIG. 3 shows a perspective view of the conceptually represented high-pressure device from FIG. 2 in a embodiment as a carwash aggregate,

FIG. 4 shows a schematic concept of a high-pressure cleaning device according to the invention of a second, preferred embodiment with two feed lines before the high-pressure pump,

FIG. 5 shows a schematic cross-sectional view of a cleaning particle of a cleaning dispersion according to the invention of a preferred embodiment, and

FIG. 6 shows a microscopic section of a cleaning dispersion according to the invention of a further, preferred embodiment.

The Figures are schematic in nature and serve only for understanding the invention. Identical elements are marked with the same reference signs. The features of the different embodiments are interchangeable.

### DETAILED DESCRIPTION

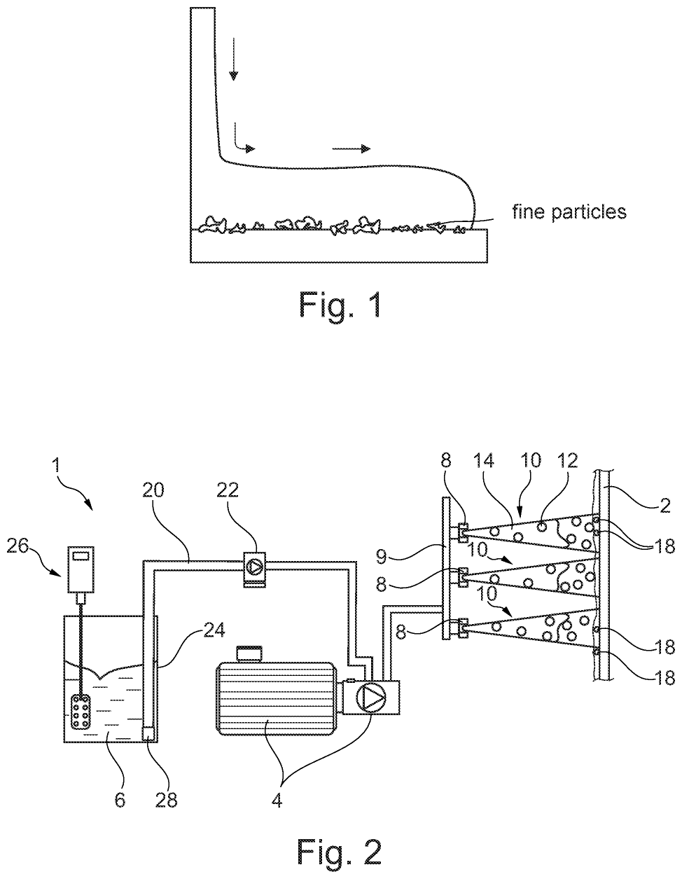

As an explanation, FIG. 1 shows a cross-sectional view of a surface on which fine particles still remain despite cleaning with a high-pressure water jet. The high-pressure water jet hitting the surface perpendicularly is deflected to the sides parallel to the surface. According to the invention, a high-pressure cleaning device as well as a cleaning dispersion for a high-pressure cleaning device is created, with which the fine particles can be removed mechanically without damaging the surface to be cleaned itself.

FIG. 2 shows in a schematic concept representation in a side view, a high-pressure cleaning device 1 according to the invention according to a first, preferred embodiment for the material-friendly cleaning of motor-vehicle surfaces 2 as well as an arrangement according to the invention of a high-pressure cleaning device 1 and the motor-vehicle surface 2. The high-pressure cleaning device 1 has a high-pressure pump 4 in the form of a centrifugal pump, which conveys a cleaning product in the form of a cleaning dispersion 6 to a high-pressure jet nozzle in the form of a flat fan nozzle 8, for brushless cleaning by means of a jetting process. From this flat fan nozzle 8, the cleaning dispersion 6 exits at high pressure as a high-pressure jet 10 and finally hits the vehicle surface 2 to be cleaned. This embodiment shows as an example three flat fan nozzles 8, which are connected via a common dispersion line 9.

Compared to the previous prior art, the high-pressure cleaning device 1 has as cleaning product a cleaning dispersion 6 with water as carrier fluid 14 and with solid cleaning particles 12 contained therein, wherein the cleaning particles 12 in this embodiment are present as ground polyurethane with a density between 1 g/cm³ and 1.25 g/cm³ and exit from the flat fan nozzle 8 with a kinetic energy between at least 4·10⁻⁷ J and at most 9·10⁻⁶ J. By combining the parameters ‘density’ and ‘kinetic energy’ of the cleaning particles in this way, material-friendly cleaning and removal of gray haze can be achieved with the applied high-pressure jet 10 of the high-pressure cleaning device 1. In concrete terms, the cleaning particles 12 contained in the high-pressure jet 10 hit the fine particles 18 adhering to the vehicle surface 2. The averagely longest dimension of the microporous and star-shaped cleaning particle 12 of the cleaning dispersion 6 having a grain structure is between 30 μm and 200 μm. Due to the short distance between the flat fan nozzle 8 and the motor vehicle surface 2 and the high proportion of water as the carrier fluid of the ready-to-use cleaning dispersion 6, the kinetic energy of the cleaning particles 12 when they hit the vehicle surface 2 is approximately equal to the kinetic energy of the cleaning particles 6 when they exit the flat fan nozzle 8.

Before or upstream of the high-pressure pump 4, there is a supply line 20, which feeds the ready-to-use cleaning dispersion 6 to the high-pressure pump 4 via a booster pump 22. As an alternative to this embodiment with the booster pump 22, the high-pressure cleaning device 1 can also be configured without the booster pump 22, so that the high-pressure pump 4 itself sucks in the cleaning dispersion 6 via a vacuum. The cleaning dispersion 6 is stored in a receiver tank 24 of the high-pressure cleaning device 1 and is fed to the high-pressure pump 4 via the supply line 20.

In order to keep the cleaning particles 12 homogeneously distributed in the cleaning dispersion 6, the high-pressure cleaning device 1 has a circulation device in the form of a stirring device 26 for the receiver tank 24, which prevents the cleaning particles 12 from being deposited in concentrated form in areas such as the bottom of the receiver tank 24. Alternatively or in addition to the stirring device 26, a circulation pump can of course also be used. As drive, the stirring device has a controllable electric motor with an stirrer attached to its output shaft, which stirs the cleaning dispersion 6. Near the bottom of the receiver tank 24, an intake socket 28 is provided at the end of the supply line, which allows for good flow suction. In addition, the intake socket 28 can be equipped with an upstream filter to keep larger or clumped cleaning particles 12 or unwanted foreign particles from entering the high-pressure pump 4.

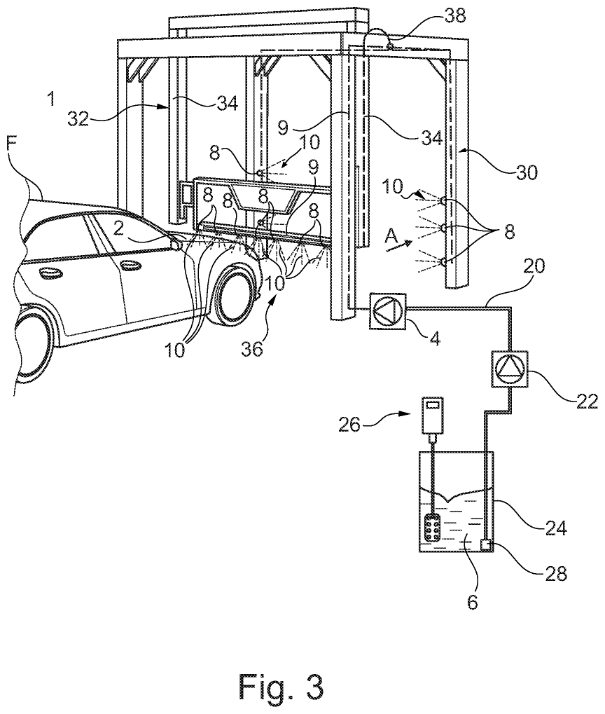

FIG. 3 shows a perspective view of the concept of the high-pressure cleaning device 1 shown in FIG. 2 in a embodiment as a carwash aggregate. In contrast to the prior art, the high-pressure cleaning device 1 does not need any brushes or washing brushes like a side brush. A cleaning frame 32 is provided on a cuboid frame structure 30 statically fixed to the floor of the carwash, which is translatorily or linearly movable in a direction of travel A of a vehicle F to be cleaned and can move along with the vehicle F. The cleaning frame 32, which can be moved translatorily in the direction of travel A, has a nozzle bar 36, which can be moved vertically and is provided between two vertical arms 34, with several, e.g. seven, flat fan nozzles 8 arranged in a row in the longitudinal direction. These flat fan nozzles 8 move with the cleaning frame 32 in the horizontal direction and via the nozzle bar 36 in the vertical direction in relation to the frame structure 30. Thus, linearly co-moving and vertically movable flat fan nozzles 8 are realized, which can clean in particular the hood, roof and trunk area of the vehicle F in a material friendly way. In order to be able to clean the front area of the vehicle F, the flat fan nozzles 8 on the nozzle bar 36 can also be rotated in a plane in the vertical direction and in the direction of travel A.

The nozzle bar 36 is to be seen as a section of the distribution line 9. The cleaning frame 32 of the high-pressure cleaning device 1 is fluidically connected to the remaining section of the dispersion line 9 via a line running along the arm 34 and via a flexible hose 38 and allows translational movement of the cleaning frame 32.

In addition to the nozzle bar 36, the high-pressure cleaning device 1 is equipped on the frame structure 30 with two vertical struts at the rear in the direction of travel A, with flat fan nozzles 8 pointing inwards towards the passing vehicle F for cleaning the side surfaces of the vehicle F. These flat fan nozzles can also be controlled (open/close) in a further embodiment not shown here, so that only the flat fan nozzles 8 required for the vehicle F are activated according to the height of the vehicle.

The receiver tank 24 with the cleaning dispersion 6 is only shown schematically in FIG. 3, which is why reference is made to the above description in FIG. 2. An optimum distance between the flat fan nozzles 8 and the vehicle surface 2 of vehicle F can be considered to be a distance between 0.1 and 1 meter. The high-pressure cleaning device 1 is optimally adapted for cleaning smooth surfaces 2 such as paint and glass of the vehicle F.

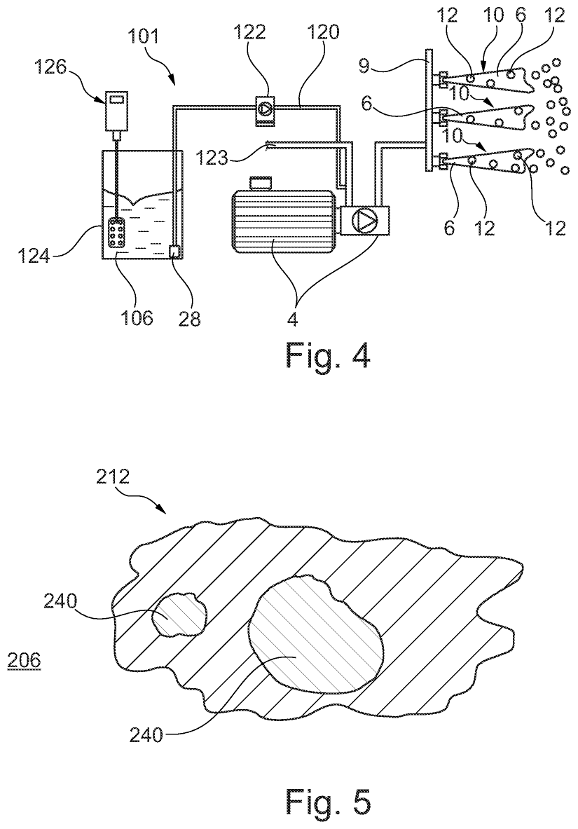

FIG. 4 shows in a schematic concept representation in a side view, a high-pressure cleaning device 101 according to the invention of a further, second, preferred embodiment. In contrast to the first, preferred embodiment in FIG. 2 and FIG. 3, the high-pressure cleaning device 101 has two feed lines, where a first feed line is again a supply line 120 which feeds an undiluted cleaning agent 106 with the contained cleaning particles 12 and a small amount of water and a washing fluid as carrier fluid 114 to the high-pressure pump 4 by means of a finely adjustable dosing pump 122 and where a second feed line 123 feeds water to form the ready-to-use cleaning dispersion 6. The undiluted cleaning agent is stored in a concentrate container 124 (as a kind of receiver tank), stirred and kept homogeneous by a stirring device 126.

This configuration of the high-pressure cleaning device 101 with the two feed lines 120, 123 ensures good handling of the required cleaning dispersion 6, since the required cleaning dispersion 6 is divided into an undiluted cleaning agent 106 with a lower mass fraction and water with a higher mass fraction. The undiluted cleaning agent 106 is constituted in such a way that on the one hand sufficient water and washing fluid are added as carrier fluid, so that the undiluted cleaning agent 106 can be still conveyed in terms of fluid dynamics. On the other hand, the undiluted cleaning agent can be transported, stored and made available to the high-pressure cleaning device 101 for example in canisters in a space-saving manner. The undiluted cleaning agent 106 is added upstream or before the high-pressure pump 4 and forms the ready-to-use cleaning dispersion 6 before the high-pressure area. This configuration is very efficient, as significantly more water is required for a wash cycle of the vehicle F. The downstream part of the high-pressure cleaning device 101 is designed in the same way as in the first embodiment after the two feed lines 120 and 123 have merged.

FIG. 5 is a schematic sectional view of a single cleaning particle 212 of a cleaning dispersion 206 according to the invention according to a further, preferred embodiment. This cleaning particle 212 has an inorganic filler 240 such as a mineral, for example spat or baryte, which, formed as two ‘cores’ of the cleaning particle 212, is enclosed or encapsulated by a polymer, in this embodiment polyurethane (PU). This symbiotic concept combines both the soft properties of the enveloping polyurethane for material-friendly cleaning and the high density of the inorganic filler 240 in order to achieve an optimum of the different material properties.

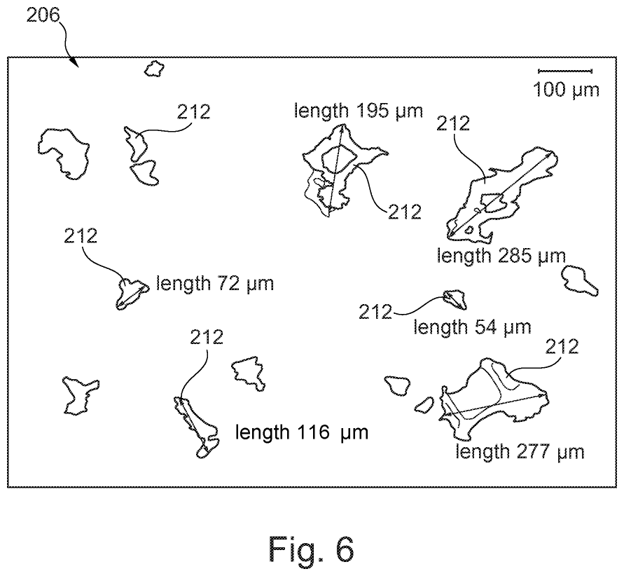

FIG. 6 shows a microscope image of a cleaning dispersion 206 with cleaning particles 212. The cleaning particles 212 with a grain structure, which are property-stable (water-insoluble) in the cleaning dispersion 206, have different average longest dimensions, which are shown in FIG. 6. The cleaning particles 212 have a mass percentage of 1% or a percentage of 1% by weight of the cleaning dispersion 206 as an optimal balance between handling and (in an application) effect per time.

There are of course further embodiments of the high-pressure cleaning device or of the cleaning dispersion conceivable. For example, the high-pressure cleaning device can also be designed as a brushless gantry car wash, in which high-pressure jet nozzles are positioned and driven/moved along the vehicle instead of the brushes. Here, as with the car wash, a driving speed can be set according to the degree of contamination of the vehicle to be cleaned. The more dirt has to be removed, the slower is the driving speed of the gantry washing system. After cleaning, rinsing and/or conventional drying or a drain dryer can be used as usual. This allows for easy discharge from existing aggregates and the new aggregates can be integrated into the existing platform. Alternatively, a high-pressure cleaning device according to the invention of an alternative embodiment can also be designed as a standing arch through which an object to be cleaned is moved or through which a vehicle passes. The space requirement is particularly small here.

In addition to the immobile embodiments described above, a high-pressure cleaning device can alternatively be designed in a embodiment as a portable, compact unit, similar to a portable high-pressure cleaner. With a high-pressure lance, a user can direct the high-pressure jet at the area to be cleaned and apply it there. Thus, the user is provided with a portable high-pressure cleaning device according to the invention, which he can also use at home, for example in the yard (with an appropriate collecting basin for the sprayed cleaning dispersion, if it is not biodegradable).

Of course, prior to cleaning with the high-pressure jet nozzle and the cleaning dispersion according to the invention, (conventional) pre-cleaning with a detergent or water can also be performed. In this way, the cleaning result can be further improved.

1. A high-pressure cleaning device for material-friendly cleaning of surfaces contaminated with fine particles, in particular motor-vehicle surfaces, comprising a high-pressure pump for conveying a cleaning product to a high-pressure jet nozzle at which the cleaning product exits in a high-pressure jet, wherein the cleaning product comprises a cleaning dispersion with a carrier fluid and with solid cleaning particles with a density of between 0.8 g/cm³ and 3.5 g/cm³, preferably between 0.9 g/cm³ and 2.2 g/cm³, and the high-pressure cleaning device is configured in such a way that a cleaning particle, upon exiting the high-pressure jet nozzle, has a kinetic energy of a minimum of 1·10⁻¹⁰ J and a maximum of 2·10⁻⁴ J.

2. The high-pressure cleaning device according to claim 1, wherein the cleaning particles have an average longitudinal extension of a minimum of 20 μm and/or a maximum of 315 μm.

3. The high-pressure cleaning device according to claim 1, wherein the speed of the high-pressure jet when it exits the high-pressure jet nozzle is a minimum of 20 m/s and/or a maximum of 80 m/s.

4. The high-pressure cleaning device according to claim 1, wherein the high-pressure cleaning device has a storage container for storing the cleaning dispersion, the storage container comprising a circulating device for circulating the cleaning dispersion in order to keep the distribution of the cleaning particles homogeneous.

5. The high-pressure cleaning device according to claim 1, wherein upstream of the high-pressure pump, the high-pressure cleaning device has a supply line which supplies the cleaning dispersion upstream of the high-pressure area.

6. The high-pressure cleaning device according to claim 1, wherein upstream of the high-pressure pump, the high-pressure cleaning device has two feed lines, in which a first feed line supplies an cleaning agent concentrate with the cleaning particles, and in which a second feed line supplies a further fluid which together as a mixture form the cleaning dispersion, so that the cleaning agent concentrate and the further fluid are mixed before the high-pressure area.

7. The high-pressure cleaning device according to claim 6, wherein the high-pressure cleaning device comprises a concentrate container for storing the cleaning agent concentrate and the cleaning agent concentrate is supplied via the first feed line via a dosing device.

8. The high-pressure cleaning device according to claim 1, wherein the high-pressure cleaning device comprises at least one high-pressure injector before the high-pressure jet nozzle and downstream of the high-pressure pump for injecting an cleaning agent concentrate with the cleaning particles into the high-pressure area.

9. A cleaning dispersion for a high-pressure cleaning device according to claim 1, the cleaning dispersion comprising a carrier fluid and with and solid cleaning particles dispersed in the carrier fluid, wherein the cleaning particles have a density between 0.8 g/cm³ and 3.5 g/cm³.

10. The cleaning dispersion according to claim 9, wherein the cleaning particles contain an inorganic filler as a core, which is enclosed or encapsulated by a polymer.

11. The cleaning dispersion according to claim 9, wherein the cleaning particles have a grain structure and are preferably microporous and/or preferably have a star-shaped form.

12. The cleaning dispersion according to claim 9, wherein the cleaning particles of the cleaning dispersion have a mass percentage between 0.1% and 5% of the cleaning dispersion.

13. A high-pressure cleaning device in combination with a surface to be cleaned, the high-pressure cleaning device configured for material-friendly cleaning with a high-pressure pump for conveying a cleaning product to a high-pressure jet nozzle, at which the cleaning product exits in a high-pressure jet, wherein the cleaning product comprises a cleaning dispersion with a carrier fluid and with solid cleaning particles with a density between 0.8 g/cm³ and 3.5 g/cm³, and the high-pressure cleaning device is configured in such a way that a cleaning particle, when hitting the surface, has a kinetic energy of a minimum of 1·10⁻¹⁰ J and a maximum of 2·10⁻⁴ J.

14. The high-pressure cleaning device in combination with the surface to be cleaned according to claim 13, wherein a distance between the high-pressure cleaning device and the surface to be cleaned is less than 1 meter.

15. The cleaning dispersion according to claim 9, wherein the cleaning particles are made of a polymer.

16. The cleaning dispersion according to claim 9, wherein the cleaning particles have stable properties.

17. The cleaning dispersion according to claim 9, wherein the cleaning particles are microporous or have a star-shaped form.
